(19) United States
(12) Patent Application Publication
(10) Pub. No.: US 2009/0130317 A1
(43) Pub. Date: May 21, 2009

(54) HOT AIR DRIER ASSEMBLY FOR A WATERBORNE PAINT SPRAY BOOTH

(76) Inventor: JOHN R. MOORE, Lansdale, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/262,695

(22) Filed: Oct. 31, 2008

Related U.S. Application Data
(60) Provisional application No. 60/989,239, filed on Nov. 20, 2007.

(51) Int. Cl. B05D 3/04; B05C 11/00

(52) U.S. Cl. 427/378; 118/58

(57) ABSTRACT

The disclosure relates to a hot air drier assembly for a solvent and waterborne paint spray booth for drying a substrate coated with liquid waterborne basecoat located inside the spray booth, comprising: a free-standing portable heat exchange device with a hot air outlet directed towards the substrate and a heat exchange fluid heating device located remotely from the paint spray booth and in fluid communication with the heat exchange device via heat exchange fluid conduits which are in fluid communication with heat exchange fluid conducting tubes for heating spray booth air directed from the spray booth air intake to the heat is exchange chamber and out the hot air outlet. The disclosure additionally relates to a paint spray booth incorporating the hot air drier assembly and methods for drying a substrate using the hot air drier assembly.

This application claims the benefit of U.S. Provisional Application No. 60/989,239 filed Nov. 20, 2007 which is incorporated herein by reference in its entirety.

### FIELD OF THE INVENTION

The present disclosure relates to drying of liquid waterborne coatings for automotive coating applications and, more particularly, to a hot air drier assembly comprising a heat exchange device and a remote heat exchange fluid heating device, the heat exchange device can be free standing and can be moveable for drying waterborne coatings for automotive body parts.

### BACKGROUND OF THE INVENTION

Today's automobile bodies are treated with multiple layers of coatings which enhance the appearance of the automobile, for example, color, metallic effects, gloss etc., and also provide protection from, for example, corrosion, chipping, ultraviolet light, chemicals and other environmental conditions which can deteriorate the coating appearance and underlying car body.

The formulations of these coatings can vary widely. However, a major challenge that faces all automotive manufacturers and refinishers is how to rapidly dry these coatings with minimal capital investment and floor space, which is valued at a premium in manufacturing plants and refinish shops.

Automotive manufacturers and refinish shops are also responding to environmental concerns with increased substitution of waterbased materials in place of solvent-based materials. This can place an additional burden on the drying and curing process, since waterbased materials can, in hot humid climates, require longer drying times for the necessary water evaporation.

High humidity can increase the time required to dry waterborne paints. Increasing air movement during the drying stage can shorten the drying time, but as the relative humidity approaches the dewpoint, the driving force for evaporation of water from the paint decreases making unheated air ineffective. Adding heat to the drying process would help dry waterborne paints, especially in high humidity climates.

The process of applying atomized liquid coatings, especially solvent borne liquid coatings, generates potentially dangerous gaseous and particulate byproducts that are controlled or managed by confining them in an enclosure known as a spray booth and conveying them away from the process by entraining them in a moving air stream. The drying process is also usually carried out in the spray booth. The exhaust air stream typically passes through one or more stages of filtration to remove the particulates before the gaseous or vaporous byproducts are exhausted into the atmosphere. For economical reasons, paint booths, especially those in refinish shops, are often used for applying and drying both solvent borne and waterborne coatings. Thus, any devices used in paint booths must meet Class 1 Division 1 specifications because of the flammability of the ingredients in solvent borne coatings. As such, heating devices for use in paint drying in the paint booths must be explosion proof which can lead to very expensive, complicated and cumbersome electrical heating equipment.

### SUMMARY OF THE INVENTION

The present disclosure relates to a hot air drier assembly for a solvent and waterborne paint spray booth for drying a substrate coated with liquid waterborne basecoat, comprising:
(a) a free-standing portable heat exchange device having a spray booth air intake manifold connected to a heat exchange chamber having a hot air outlet, the air intake manifold for directing spray booth air to the heat exchange chamber and out the hot air outlet, the heat exchange chamber having a first heat exchange fluid inlet and a first heat exchange fluid outlet;
(b) a plurality of heat exchange fluid conducting tubes spaced within the heat exchange chamber being in fluid communication with the heat exchange fluid inlet and the heat exchange fluid outlet;
(c) a fin assembly being in heat transferring contact with the heat exchange fluid conducting tubes and having apertures through which the heat exchange fluid conducting tubes pass; and
(d) a heat exchange fluid heating device located remotely from the paint spray booth and in fluid communication with the heat exchange fluid conducting tubes, the heat exchange fluid heating device having a second heat exchange fluid inlet being in fluid communication with the first heat exchange fluid outlet and a second heat exchange fluid outlet being in fluid communication with the first heat exchange fluid inlet, the heat exchange fluid heating device having a heating source located in an internal cavity thereof for heating a heat exchange fluid which is capable of flowing from the heat exchange fluid heating device, via the second heat exchange fluid outlet, to the heat exchange fluid conducting tubes of the heat exchange device via the first heat exchange fluid inlet for supplying heat to the heat exchange chamber for heating the spray booth air directed from the spray booth air intake to the heat exchange chamber and out the hot air outlet.

The heat exchange fluid can be a liquid, gas or gel, typically, water.

The heat exchange fluid heating device can be an on-demand tankless heat exchange fluid heater, such as a tankless water heater. The heating source of the heater can be an electric or natural gas heating element.

The spray booth air intake manifold can further comprise a compressed air jet for entraining the booth air to facilitate passing the booth air to the heat exchange chamber. The spray booth air intake manifold can further comprise a duct for transferring spray booth air supply to the spray booth air intake manifold.

To add an infrared source of heat, the heat exchange chamber can further comprise a reflector for reflecting heat from the heat exchange conducting tubes towards the hot air outlet.

The heat exchange device can further comprise a fan positioned to increase the velocity of the spray booth air as it is passed to the heat exchange chamber and out the hot air outlet.

In another embodiment, the disclosure relates to a waterborne paint drying system for drying a substrate painted with a waterborne paint, the system comprising a spray booth having an enclosure, an air inlet, an air outlet and means for supplying air to the inlet to create an airflow through the enclosure from the air inlet to the air outlet, the system further comprising the hot air drier assembly.

In yet another embodiment, the disclosure relates to a method for drying a substrate coated with liquid waterborne basecoat in a paint spray booth, comprising: a free-standing portable heat exchange device inside the paint spray booth, the heat exchange device having
(i) a spray booth air intake manifold connected to a heat exchange chamber having a hot air outlet, the air intake manifold for directing spray booth air to the heat exchange chamber and out the hot air outlet, the heat exchange chamber having a first heat exchange fluid inlet and a first heat exchange fluid outlet;
(ii) a plurality of heat exchange fluid conducting tubes spaced within the heat exchange chamber being in fluid communication with the heat exchange fluid inlet and the heat exchange fluid outlet;
(iii) a fin assembly being in heat transferring contact with the heat exchange fluid conducting tubes and having apertures through which the heat exchange fluid conducting tubes pass; and
(b) providing a heat exchange fluid heating device remotely from the paint spray booth and in fluid communication with the heat exchange fluid conducting tubes, the heat exchange fluid heating device having a second heat exchange fluid inlet being in fluid communication with the first heat exchange fluid outlet and a second heat exchange fluid outlet being in fluid communication with the first heat exchange fluid inlet, the heat exchange fluid heating device having a heating source located in an internal cavity thereof for heating a heat exchange fluid which is capable of flowing from the heat exchange fluid heating device, via the second heat exchange fluid outlet, to the heat exchange fluid conducting tubes of the heat exchange device via the first heat exchange fluid inlet for supplying heat to the heat exchange chamber for heating the spray booth air directed from the spray booth air intake to the heat exchange chamber and out the hot air outlet.

The hot air drier assembly is easy to use, does not require the costly and complicated electrical heating equipment adapted for use in a solvent borne paint environment and will meet the Class 1 Division 1 specifications which apply to paint booths in which solvent borne paints are used. A heat exchange fluid heating device located remote from the paint spray booth avoids the need for costly and complicated electrical heating equipment for use in the spray booth. Moreover, the heat exchange device which delivers heated air to the substrate can be free standing so that the heated air can be easily directed towards localized regions of the substrate coated with the liquid waterborne basecoat.

### BRIEF DESCRIPTION OF THE DRAWINGS

The foregoing summary, as well as the following detailed description of the preferred embodiments, will be better understood when read in conjunction with the appended drawings. In the drawings:

FIG. 1 is a diagrammatic view of a hot air drier assembly according to one embodiment of the disclosure;

FIG. 2 is a diagrammatic view of a paint spray booth with the hot air drier assembly according to one embodiment of the disclosure.

### DETAILED DESCRIPTION OF THE INVENTION

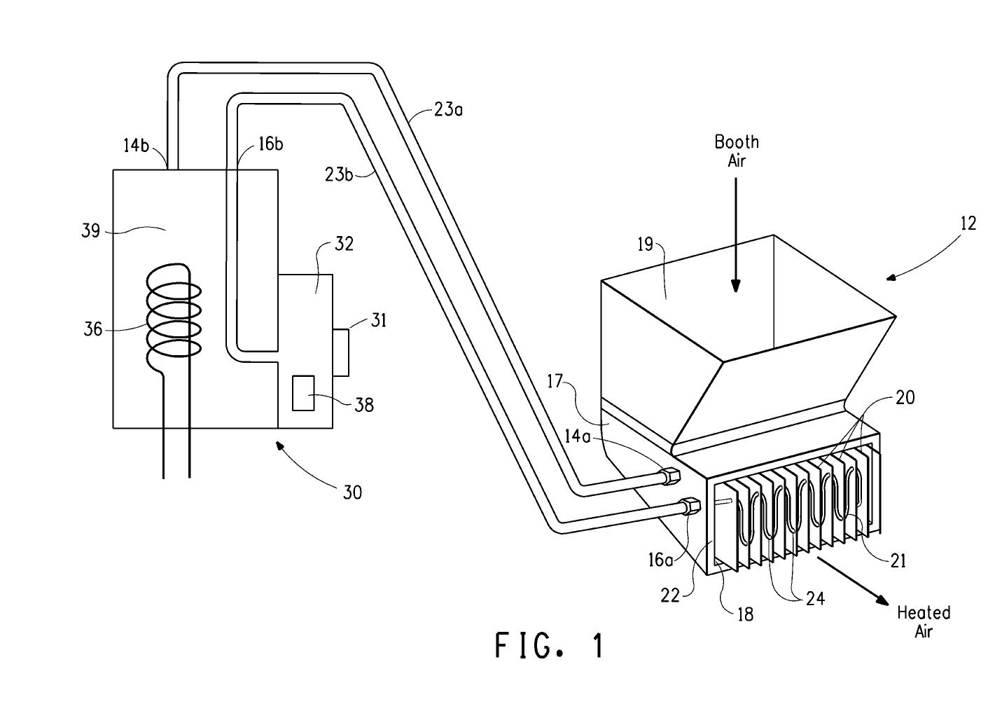

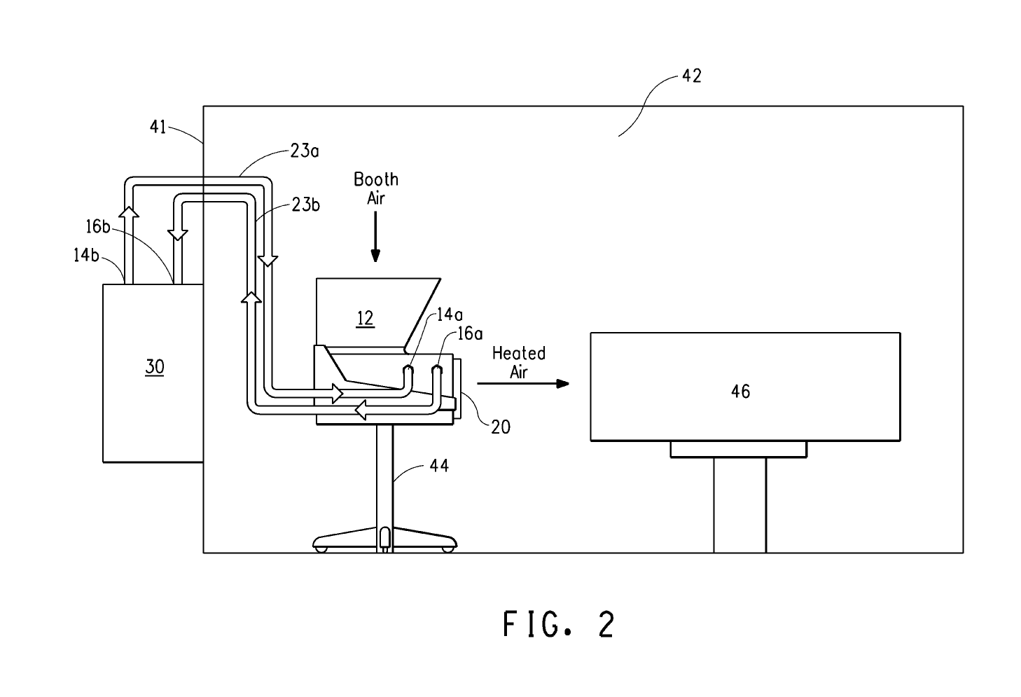

Referring to the drawings, in which like numerals indicate like elements throughout, there is shown in FIG. 1 a diagrammatic view of a hot air drier assembly according to one embodiment of the disclosure. Referring to FIG. 2 is shown a diagrammatic view of a paint spray booth with the hot air drier assembly showing the heat exchange device positioned in front of a substrate and the heat exchange fluid heating device located remotely from the paint spray booth according to one embodiment of the disclosure.

The assembly of the present disclosure is suitable for drying any liquid waterborne coating, particularly automotive coatings, such as primers, primer-surfacers, basecoats, and clearcoats. The present disclosure will now be discussed generally in the context of drying liquid waterborne basecoats for subsequent topcoat application. One skilled in the art would understand that the assembly of the present disclosure also is useful for drying substrates coated with liquid waterborne primers, primer-surfacers, and/or topcoats.

This device can be most suitable for coating metal or polymeric substrates in a batch process. In a batch process, the substrate is stationary during each treatment step of the process, whereas in a continuous process the substrate is in continuous movement along an assembly line.

Useful substrates that can be coated according to the process of the present disclosure include metal substrates, polymeric substrates, such as thermoset materials and thermoplastic materials, and combinations thereof. Useful metal substrates that can be coated according to the process of the present invention include ferrous metals such as iron, steel, and alloys thereof, non-ferrous metals such as aluminum, zinc, magnesium and alloys thereof, and combinations thereof. Preferably, the substrate is formed from cold rolled steel, electrogalvanized steel such as hot dip electrogalvanized steel or electrogalvanized iron-zinc steel, aluminum or magnesium.

Useful thermoset materials include polyesters, epoxides, phenolics, polyurethanes such as reaction injected molding urethane (RIM) thermoset materials and mixtures thereof. Useful thermoplastic materials include thermoplastic polyolefins such as polyethylene and polypropylene, polyamides such as nylon, thermoplastic polyurethanes, thermoplastic polyesters, acrylic polymers, vinyl polymers, polycarbonates, acrylonitrilebutadiene-styrene (ABS) copolymers, EPDM rubber, copolymers and mixtures thereof.

Preferably, the substrates are used as components to fabricate automotive vehicles, including but not limited to automobiles, trucks and tractors. The substrates can have any shape, but are preferably in the form of automotive body components such as bodies (frames), hoods, doors, fenders, bumpers and/or trim for automotive vehicles.

The present disclosure first will be discussed generally in the context of coating a metallic automobile body. One skilled in the art would understand that the assembly is useful for coating non-automotive metal and/or polymeric components.

Referring to FIG. 2 of the drawings, a paint spray booth 42 is shown. The heat exchange device 12 is positioned on a pedestal 44 which can be moveable by being mounted on wheels so that it can be positioned to orient the flow of heated air towards a localized portion of the substrate 46. Unlike a replacement air system for a spray paint booth in which substantially if not all the air to and/or in the booth is heat exchanged, the assembly of this disclosure heat exchanges a minor proportion of the air for localized drying of the substrate by applying heat to the substrate. A conduit 23, preferably a flexible conduit, transfers the cooled heat exchange fluid from the first heat exchange fluid outlet 16a of the heat exchange device 12 to the second heat exchange fluid inlet 16b of the heat exchange fluid heating device 30. In the heat exchange fluid heating device, the temperature of the heat exchange fluid is elevated by a heating source 36 located within a heat exchange fluid chamber 39 of the heat exchange device as best shown in FIG. 1. Preferably the heating source is an electrical heating element or natural gas heating source.

The heat exchange fluid is circulated within the internal cavity via fluid circulating pump and flow sensor 38 of box 32 and the heated heat exchange fluid flows from the second heat exchange fluid outlet 14b via a conduit, preferably a flexible conduit, to the first inlet 14a of the heat exchanger. The conduit can be insulated and the portion of the conduit which is located outside the spray booth can be heat traced to maintain the temperature of the heat exchange fluid.

As shown in FIG. 1, the heat exchange fluid passes through the heat exchange fluid conducting tubes 21. The heat exchange fluid conducting tubes are attached in a fluid tight manner to the first inlet and first outlet of the heat exchange chamber 18. The plurality of tubes are arranged in series, preferably positioned vertically, within the chamber 18. The tubes need not be uniformly spaced although that could be beneficial. The tubes can be continuous and composed of a thermally conductive material. A first end of the tubes is sealingly connected to the first inlet 14a and a second end of the tubes is sealingly connected to the first outlet 16a. In one embodiment the array of tubes lie in the same plane, although it is possible to offset adjacent tubes and there can be more than one row of tubes.

Also located in the heat exchange chamber is a fin assembly 20 best shown in FIG. 1 in the form of concentrically disposed heat transfer fins which are in heat transferring contact with the tubes. The fins are made of thermally conductive material. The fins are provided with apertures 24 through which the heat exchange tubes pass, the apertures of the fins or portions thereof being in alignment for passage of the tubes there through.

The booth air intake manifold 19 of the heat exchange device may comprise air nozzles or jets (not shown) which are mounted internally of the manifold and are operable to increase the volume of air flowing into the heat exchange chamber 18 of the heat exchange device by entraining the booth air. Another way the volume of air supply can be increased is by supplying compressed air to the intake manifold 19 by means of an air compression device. The spray booth air intake manifold 19 can further comprise a duct attached thereto for transferring spray booth air supply to the spray booth air intake manifold.

An additional source of heat can be provided by adding an infrared source of heat. In one example for adding a source of heat, a reflector (not shown) can be attached to the chamber for reflecting heat from the heat exchange conducting tubes towards the hot air outlet 22. Suitable reflective materials and methods for anchoring the reflector to the chamber will be apparent to those skilled in the art of heat exchange technology. The heat exchange device can further comprise a fan positioned to increase the velocity of the spray booth air as it is passed to the heat exchange chamber and out the hot air outlet. The fan can be positioned in any suitable location within the heat exchange device to direct both air from the intake manifold 19 towards the heat exchange chamber 18, but one suitable location for the fan can be in the internal passageway 17 which connects the intake manifold 19 to the heat exchange chamber 18.

The heat exchange fluid heating device 30 of FIG. 1 shows an internal heating element shown as electric coil 36. In one possible manner of operation, once the heating device 30 is connected on a wall remote from the inside of the spray booth, for example on an outside wall 41 of the spray booth as shown in FIG. 2, for example, and the second heat exchange fluid outlet 14b is opened to allow the heat exchange fluid to flow from the heat exchange fluid chamber 39 through the outlet 14b, the pressure in the flow sensing/heat element activating means activates a switch 31 to supply power to the heating element 36 to substantially instanteously heat the heat exchange fluid in the chamber 39. When the heat exchange device is turned off, heat exchange fluid will no longer exit the chamber 39 through the second outlet 14b, and the flow sensing/heat element activating means 32 will actuate the switch 31 to cut-off power to the heating element 36.

Suitable heat exchange fluid heating devices can be devices similar to those used in tankless water heater systems including, without limit, the kind disclosed in U.S. Pat. Nos. 6,574,426; 6,351,603; 6,941,756; 6,684,822 and 6,389,226.

The heat exchange fluid can be a liquid, gas or gel, typically, the heat exchange fluid is water.

In another embodiment, the disclosure relates to a waterborne paint drying system for drying a substrate painted with a waterborne paint 46, the system comprising a spray booth 42 having an enclosure, an air inlet, an air outlet and means for supplying air to the inlet to create an airflow through the enclosure from the air inlet to the air outlet, the system further comprising the hot air drier assembly. Spray booth configurations and their air flows are well known and certain examples are shown and described in U.S. Patent Application No. 2005/0229921 and U.S. Pat. No. 6,684,528.

The disclosure additionally relates to a method for drying a substrate coated with liquid waterborne basecoat, typically an automobile body part, in a paint spray booth, comprising: a free-standing portable heat exchange device 12 inside the paint spray booth, the heat exchange device having
(i) a spray booth air intake manifold 19 connected to a heat exchange chamber 18 having a hot air outlet 22, the air intake manifold for directing spray booth air to the heat exchange chamber and out the hot air outlet 22, the heat exchange chamber having a first heat exchange fluid inlet 14a and a first heat exchange fluid outlet 16a;
(ii) a plurality of heat exchange fluid conducting tubes 21 spaced within the heat exchange chamber being in fluid communication with the heat exchange fluid inlet 14a and the heat exchange fluid outlet 16a;
(iii) a fin assembly 20 being in heat transferring contact with the heat exchange fluid conducting tubes 21 and having apertures 24 through which the heat exchange fluid conducting tubes pass; and
(b) providing a heat exchange fluid heating device 30 remotely from the paint spray booth 42 and in fluid communication with the heat exchange fluid conducting tubes, the heat exchange fluid heating device having a second heat exchange fluid inlet 16b being in fluid communication with the first heat exchange fluid outlet 16a and a second heat exchange fluid outlet 14b being in fluid communication with the first heat exchange fluid inlet 14a, the heat exchange fluid heating device having a heating source 36 located within an internal cavity 39 for heating a heat exchange fluid which is capable of flowing from the heat exchange fluid heating device, via the second heat exchange fluid outlet, to the heat exchange fluid conducting tubes of the heat exchange device via the first heat exchange fluid inlet for supplying heat to the heat exchange chamber for heating the spray booth air directed from the spray booth air intake manifold to the heat exchange chamber and out the hot air outlet 22.

Applicants specifically incorporate the entire content of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the disclosure be limited to the specific values recited when defining a range. It is to be appreciated that certain features of the disclosure which are, for clarity, described above and below in the context of separate embodiments, may also be provided separately or in any subcombination. In addition, references in the singular may also include the plurar (for example, “a” and “an” may refer to one, or more) unless the context specifically states otherwise.

In one embodiment, the disclosure herein can be construed as excluding any element or process step that does not materially affect the basic and novel characteristics of the composition or process. Additionally, the disclosure can be construed as excluding any element or process step not specified herein.

It will be appreciated by one skilled in the art that changes made from the embodiments heretofore described would not result in a departure from the inventive concept. It is therefore understood that this invention is not limited to the particular embodiments disclosed, but is intended to cover modifications that are within the spirit and scope of the invention as defined by the appended claims.

We claim:

1. A hot air drier assembly for a solvent and waterborne paint spray booth for drying a substrate coated with liquid waterborne basecoat, comprising:
(a) a free-standing portable heat exchange device having a spray booth air intake manifold connected to a heat exchange chamber having a hot air outlet, the air intake manifold for directing spray booth air to the heat exchange chamber and out the hot air outlet, the heat exchange chamber having a first heat exchange fluid inlet and a first heat exchange fluid outlet;
(b) a plurality of heat exchange fluid conducting tubes spaced within the heat exchange chamber being in fluid communication with the heat exchange fluid inlet and the heat exchange fluid outlet;
(c) a fin assembly being in heat transferring contact with the heat exchange fluid conducting tubes and having apertures through which the heat exchange fluid conducting tubes pass; and
(d) a heat exchange fluid heating device located remotely from the paint spray booth and in fluid communication with the heat exchange fluid conducting tubes, the heat exchange fluid heating device having a second heat exchange fluid inlet being in fluid communication with the first heat exchange fluid outlet and a second heat exchange fluid outlet being in fluid communication with the first heat exchange fluid inlet, the heat exchange fluid heating device having a heating source located in an internal cavity thereof for heating a heat exchange fluid which is capable of flowing from the heat exchange fluid heating device, via the second heat exchange fluid outlet, to the heat exchange fluid conducting tubes of the heat exchange device via the first heat exchange fluid inlet for supplying heat to the heat exchange chamber for heating the spray booth air directed from the spray booth air intake to the heat exchange chamber and out the hot air outlet.

2. The hot air drier assembly of claim 1 in which the heat exchange fluid is selected from the group consisting of liquid, gas and gel.

3. The hot air drier assembly of claim 1 in which the heat exchange fluid is water.

4. The hot air drier assembly of claim 1 in which the heat exchange fluid heating device is an on-demand tankless water heater.

5. The hot air drier assembly of claim 1 in which the heating source is an electric or natural gas heating element.

6. The hot air drier assembly of claim 1 in which the spray booth air intake further comprises a compressed air jet for entraining the booth air to facilitate passing the booth air to the heat exchange chamber.

7. The hot air drier assembly of claim 1 in which the spray booth air intake further comprises a duct for transferring spray booth air supply to the spray booth air intake manifold.

8. The hot air drier assembly of claim 1 in which the heat exchange chamber further comprises a reflector for reflecting heat from the heat exchange conducting tubes towards the hot air outlet.

9. The hot air drier assembly of claim 1 in which the heat exchange device further comprises a fan positioned to increase the velocity of the spray booth air as it is passed to the heat exchange chamber and out the hot air outlet.

10. A waterborne paint drying system for drying a substrate painted with a waterborne paint, the system comprising a spray booth having an enclosure, an air inlet, an air outlet and means for supplying air to the inlet to create an airflow through the enclosure from the air inlet to the air outlet, the system further comprising: a hot air drier assembly, comprising:
(a) a free-standing portable heat exchange device having a spray booth air intake manifold connected to a heat exchange chamber having a hot air outlet, the air intake manifold for directing spray booth air to the heat exchange chamber and out the hot air outlet, the heat exchange chamber having a first heat exchange fluid inlet and a first heat exchange fluid outlet;
(b) a plurality of heat exchange fluid conducting tubes spaced within the heat exchange chamber being in fluid communication with the heat exchange fluid inlet and the heat exchange fluid outlet;
(c) a fin assembly being in heat transferring contact with the heat exchange fluid conducting tubes and having apertures through which the heat exchange fluid conducting tubes pass; and
(d) a heat exchange fluid heating device located remotely from the paint spray booth and in fluid communication with the heat exchange fluid conducting tubes, the heat exchange fluid heating device having a second heat exchange fluid inlet being in fluid communication with the first heat exchange fluid outlet and a second heat exchange fluid outlet being in fluid communication with the first heat exchange fluid inlet, the heat exchange fluid heating device having a heating source located in an internal cavity thereof for heating a heat exchange fluid which is capable of flowing from the heat exchange fluid heating device, via the second heat exchange fluid outlet, to the heat exchange fluid conducting tubes of the heat exchange device via the first heat exchange fluid inlet for supplying heat to the heat exchange chamber for heating air directed from the spray booth air intake to the heat exchange chamber and out the hot air outlet.

11. The waterborne paint drying system of claim 10 in which the heat exchange fluid is selected from the group consisting of liquid, gas and gel.

12. The waterborne paint drying system of claim 10 in which the heat exchange fluid is water.

13. The waterborne paint drying system of claim 10 in which the heat exchange fluid heating device is an on-demand tankless water heater located.

14. The waterborne paint drying system of claim 10 in which the heating source is an electric or natural gas heating element.

15. The waterborne paint drying system of claim 10 in which the spray booth air intake further comprises a compressed air jet for entraining the booth air to facilitate passing the booth air to the heat exchange chamber.

16. The waterborne paint drying system of claim 10 in which the means for supplying air to the inlet comprises a duct assembly and the duct assembly is connected to the air intake manifold to transfer the supplied air to the air intake manifold.

17. The waterborne paint drying system of claim 10 in which the heat exchange chamber further comprises a reflector for reflecting heat from the heat exchange conducting tubes towards the hot air outlet.

18. The waterborne paint drying system of claim 10 in which the heat exchange device further comprises a fan positioned to increase the velocity of the spray booth air as it is passed to the heat exchange chamber and out the hot air outlet.

19. A method for drying a substrate coated with liquid waterborne basecoat in a paint spray booth, comprising:
(a) providing a free-standing portable heat exchange device inside the paint spray booth, the heat exchange device having:
(i) a spray booth air intake manifold connected to a heat exchange chamber having a hot air outlet, the air intake manifold for directing spray booth air to the heat exchange chamber and out the hot air outlet, the heat exchange chamber having a first heat exchange fluid inlet and a first heat exchange fluid outlet;
(ii) a plurality of heat exchange fluid conducting tubes spaced within the heat exchange chamber being in fluid communication with the heat exchange fluid inlet and the heat exchange fluid outlet;
(iii) a fin assembly being in heat transferring contact with the heat exchange fluid conducting tubes and having apertures through which the heat exchange fluid conducting tubes pass; and
(b) providing a heat exchange fluid heating device remotely from the paint spray booth and in fluid communication with the heat exchange fluid conducting tubes, the heat exchange fluid heating device having a second heat exchange fluid inlet being in fluid communication with the first heat exchange fluid outlet and a second heat exchange fluid outlet being in fluid communication with the first heat exchange fluid inlet, the heat exchange fluid heating device having a heating source located in an internal cavity thereof for heating a heat exchange fluid which is capable of flowing from the heat exchange fluid heating device, via the second heat exchange fluid outlet, to the heat exchange fluid conducting tubes of the heat exchange device via the first heat exchange fluid inlet for supplying heat to the heat exchange chamber for heating the spray booth air directed from the spray booth air intake to the heat exchange chamber and out the hot air outlet.
